(19) United States
(12) Patent Application Publication
(10) Pub. No.: US 2026/0011492 A1
(43) Pub. Date: Jan. 8, 2026

(54) MULTILAYER CERAMIC ELECTRONIC DEVICE AND MANUFACTURING METHOD OF THE SAME

(71) Applicant: TAIYO YUDEN CO., LTD., Tokyo (JP)

(72) Inventors: Tomoaki NAKAMURA, Takasaki-shi (JP); Kenichi HIRAOKA, Takasaki-shi (JP); Chizuru TOMIKAWA, Takasaki-shi (JP); Junichi SHINOZAKI, Takasaki-shi (JP); Hideya TERAOKA, Takasaki-shi (JP)

(21) Appl. No.: 19/242,178

(22) Filed: Jun. 18, 2025

(30) Foreign Application Priority Data
Jul. 8, 2024 (JP) 2024-109816

(51) Int. Cl. H01G 4/008; H01G 4/12; H01G 4/232; H01G 4/248; H01G 4/30; H01G 13/00

(52) U.S. Cl. CPC H01G 4/008; H01G 4/12; H01G 4/2325; H01G 4/248; H01G 4/30; H01G 13/006

(57) ABSTRACT

A multilayer ceramic electronic device includes an element body in which a plurality of internal electrodes and a plurality of dielectric are alternately stacked in a first direction, each of the plurality of internal electrodes being alternately exposed to each of a pair of end faces of the element body, the pair of end faces facing each other in a second direction, and a pair of external electrodes each contacting each of the plurality of internal electrodes exposed from each of the pair of end faces and having a layer in contact with each of the plurality of internal electrodes, and of which a main component is copper. A molar ratio of copper to nickel in the first internal electrode in the end margin section is greater than the molar ratio in the first internal electrode in a capacity section.

### CROSS-REFERENCE TO RELATED APPLICATION

This application is based upon and claims the benefit of priority of the prior Japanese Patent Application No. 2024-109816, filed on Jul. 8, 2024, the entire contents of which are incorporated herein by reference.

### FIELD

A certain aspect of the present disclosure relates to a multilayer ceramic electronic device and a manufacturing method of the multilayer ceramic electronic device.

### BACKGROUND

In multilayer ceramic electronic devices such as multilayer ceramic capacitors that have internal electrodes mainly made of nickel and external electrodes mainly made of copper, it is known to make the copper molar ratio in the internal electrodes on the main surface side higher than the copper concentration in the internal electrodes in the center (for example, Japanese Patent Application Publication No. 2021-15925).

### SUMMARY OF THE INVENTION

According to an aspect of the embodiments, there is provided a multilayer ceramic electronic device including: an element body in which each of a plurality of internal electrodes of which a main component is nickel and each of a plurality of dielectric layers of which a main component is ceramic are alternately stacked in a first direction, each of the plurality of internal electrodes being alternately exposed to each of a pair of end faces of the element body, the pair of end faces facing each other in a second direction; and a pair of external electrodes each contacting each of the plurality of internal electrodes exposed from each of the pair of end faces and having a layer in contact with each of the plurality of internal electrodes, and of which a main component is copper, wherein an end margin section is an end portion in the second direction of the element body as viewed from the first direction, the end margin section including, among the plurality of internal electrodes, a first internal electrode exposed to one of the pair of end faces and not including a second internal electrode exposed to other of the pair of end faces, wherein a molar ratio of copper to nickel in the first internal electrode in the end margin section is greater than a molar ratio of copper to nickel in the first internal electrode in a capacity section, and wherein the capacity section is a section in which the first internal electrode and the second internal electrode overlap each other, which is a central portion in the second direction of the element body as viewed from the first direction.

According to another aspect of the embodiments, there is provided a manufacturing method of a multilayer ceramic electronic device, the method including: preparing an element body in which each of a plurality of internal electrodes of which a main component is nickel and each of a plurality of dielectric layers of which a main component is ceramic are alternately stacked in a first direction, each of the plurality of internal electrodes being alternately exposed to each of a pair of end faces of the element body, the pair of end faces facing each other in a second direction, wherein an end margin section is an end portion in the second direction of the element body as viewed from the first direction, the end margin section including, among the plurality of internal electrodes, a first internal electrode exposed to one of the pair of end faces and not including a second internal electrode exposed to other of the pair of end faces, wherein a molar ratio of copper to nickel in the first internal electrode in the end margin section is greater than a molar ratio of copper to nickel in the first internal electrode in a capacity section, and wherein the capacity section is a section in which the first internal electrode and the second internal electrode overlap each other, which is a central portion in the second direction of the element body as viewed from the first direction; and forming a pair of external electrodes each contacting each of the plurality of internal electrodes exposed from each of the pair of end faces and having a layer in contact with each of the plurality of internal electrodes, and of which a main component is copper.

### BRIEF DESCRIPTION OF THE DRAWINGS

FIG. 1 is a partial cross-sectional perspective view of a multilayer ceramic capacitor according to an embodiment;

FIG. 2 is a cross-sectional view taken along a line A-A in FIG. 1;

FIG. 3 is a cross-sectional view taken along a line B-B in FIG. 1;

FIG. 4 is a cross-sectional view taken along a line C-C in FIG. 1;

FIG. 5 is a cross-sectional view taken along a line D-D in FIG. 1;

FIG. 6 is a flowchart of a method for manufacturing a multilayer ceramic capacitor according to an embodiment;

FIG. 7A is a plan view of a method for manufacturing a multilayer ceramic capacitor according to an embodiment;

FIG. 7B is a cross-sectional view taken along a line A-A in FIG. 7A;

FIG. 8 is a cross-sectional view of a method for manufacturing a multilayer ceramic capacitor according to an embodiment;

FIG. 9 is a cross-sectional view of a method for manufacturing a multilayer ceramic capacitor according to an embodiment;

FIG. 10A and FIG. 10B are cross-sectional views of a manufacturing method of a multilayer ceramic capacitor according to an embodiment;

FIG. 11 is a cross-sectional view of a comparative multilayer ceramic capacitor;

FIG. 12 is a cross-sectional view of a comparative multilayer ceramic capacitor;

FIG. 13A and FIG. 13B are schematic diagrams of a molar ratio of copper in internal electrodes; and

FIG. 14A and FIG. 14B are schematic diagrams of a molar ratio of copper in internal electrodes.

### DETAILED DESCRIPTION

If the copper from the external electrode diffuses into the internal electrode and reacts with the nickel, the internal electrode will expand and cracks may form in the element.

Below, with reference to drawings, an embodiment will be described using a multilayer ceramic capacitor as an example of a multilayer ceramic electronic device.

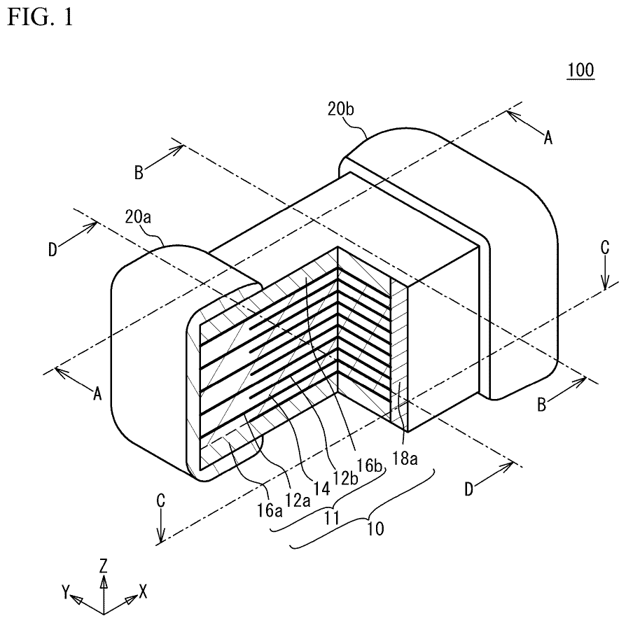

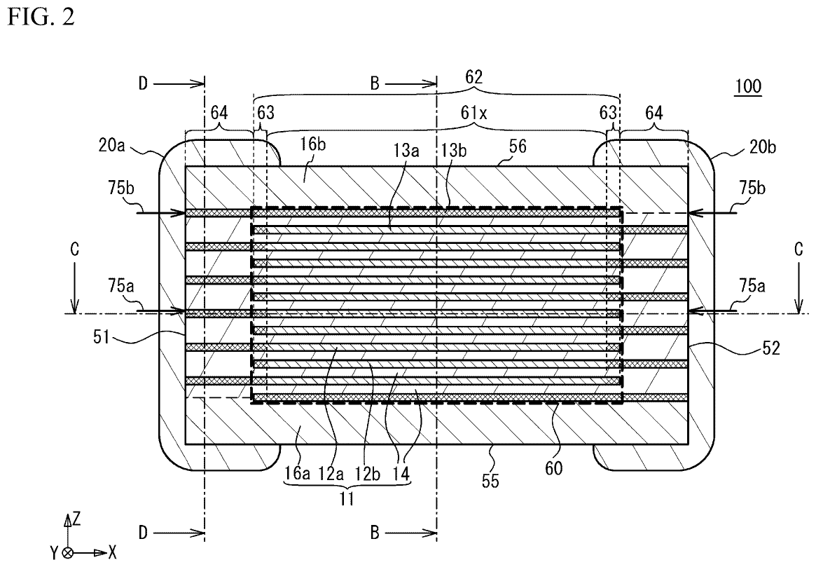

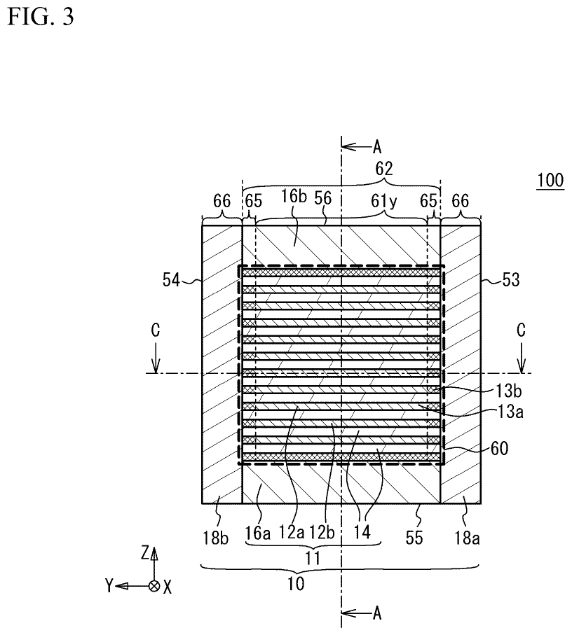

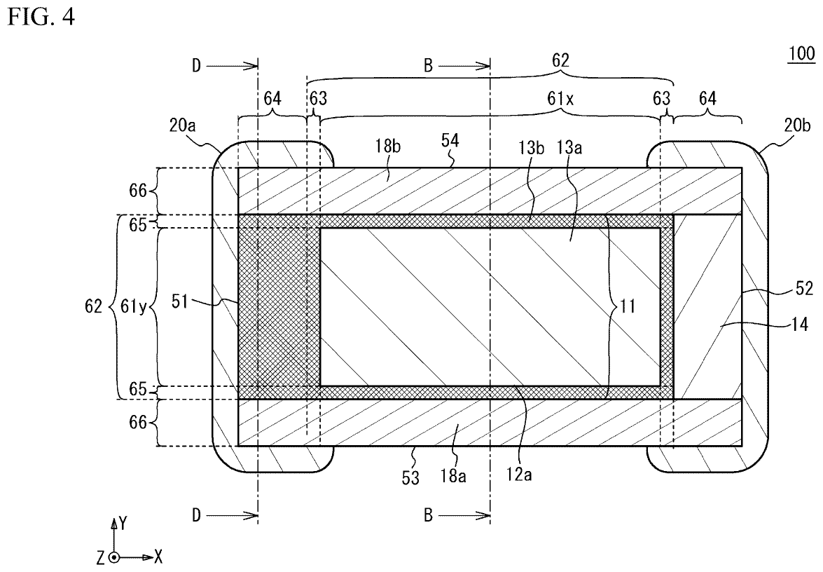

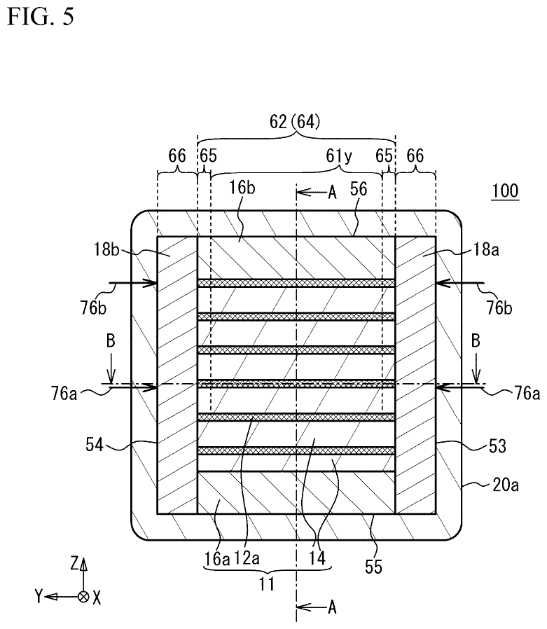

(Embodiment) FIG. 1 is a partial cross-sectional perspective view of a multilayer ceramic capacitor 100 according to an embodiment. FIG. 2 is a cross-sectional view taken along a line A-A in FIG. 1. FIG. 3 is a cross-sectional view taken along a line B-B in FIG. 1. FIG. 4 is a cross-sectional view taken along a line C-C in FIG. 1. FIG. 5 is a cross-sectional view taken along a line D-D in FIG. 1. In FIG. 2 to FIG. 5, a first portion 13a of internal electrodes 12a and 12b is illustrated by hatching with one type of parallel lines, and a second portion 13b is illustrated by cross-hatching with two types of crossed parallel lines.

In FIG. 1 to FIG. 5, the Z direction (first direction) is the stacking direction in which dielectric layers 14 and the internal electrodes 12a and 12b are stacked, and is the direction in which a lower face 55 and an upper face 56 of an element body 10 face each other. The X direction (second direction) is the length direction of the element body 10, and is the direction in which a pair of end faces 51 and 52 of the element body 10 face each other. The Y direction (third direction) is the width direction of the element body 10 and the internal electrodes 12a and 12b, and is the direction in which a pair of side faces 53 and 54 of the element body 10 face each other. The X direction, the Y direction, and the Z direction are approximately orthogonal to each other.

The multilayer ceramic capacitor 100 includes the element body 10 having an approximately rectangular parallelepiped shape, and external electrodes 20a and 20b. The element body 10 includes a multilayer body 11 and side dielectric layers 18a and 18b provided on both sides of the multilayer body 11 in the Y direction.

The multilayer body 11 includes the plurality of dielectric layers 14, the plurality of internal electrodes 12a and 12b, and cover dielectric layers 16a and 16b. The plurality of internal electrodes 12a and the plurality of internal electrodes 12b are stacked alternately. The internal electrode 12a is drawn out to one of the end faces 51, and the internal electrode 12b is drawn out to the other of the end faces 52. One of the plurality of dielectric layers 14 is provided between one of the plurality of internal electrodes 12a and one of the plurality of internal electrodes 12b. The outermost layers in the stacking direction (Z direction) of the multilayer body 11 are the internal electrodes 12a and 12b, and the lower and upper faces of the multilayer body 11 are covered by the cover dielectric layers 16a and 16b, respectively. The internal electrodes 12a and 12b are examples of first and second internal electrodes.

The regions of the internal electrodes 12a and 12b are divided into the first portion 13a and the second portion 13b. The copper concentration in the second portion 13b is higher than that in the first portion 13a. The copper concentration is expressed as the molar ratio of copper to nickel, which is the main metallic element of the internal electrodes 12a and 12b. Hereinafter, it may be expressed simply as the molar ratio of copper.

The internal electrodes 12a and 12b are alternately exposed at the end faces 51 and 52. The internal electrode 12a is exposed from the end face 51, but the internal electrode 12b is not exposed from the end face 51. The internal electrode 12b is exposed from the end face 52, but the internal electrode 12a is not exposed from the end face 52. In other words, the internal electrodes 12a and 12b are connected to the different end faces 51 and 52, respectively.

As illustrated in FIG. 2 and FIG. 4, a capacity section 60 is a central portion 62 in the X and Y directions of the element body 10 when viewed from the Z direction, and is a section where the internal electrodes 12a and 12b overlap. End margin sections 64 are the ends of the element body 10 adjacent to both sides of the central portion 62 in the X direction when viewed from the Z direction, and are a section that includes only one of the internal electrodes 12a or 12b.

For example, one of the end margin sections 64 includes the internal electrode (first internal electrode) 12a, but does not include the internal electrode (second internal electrode) 12b. The other of the end margin sections 64 includes the internal electrode (first internal electrode) 12b, but does not include the internal electrode (second internal electrode) 12a. The two end margin sections 64 each include a pull-out section where the internal electrode 12a is drawn out to the end face 51, and a pull-out region where the internal electrode 12b is drawn out to the end face 52.

In addition, in the Z direction, the uppermost internal electrode 12a and the lowermost internal electrode 12b each do not have the first portion 13a, and only have the second portion 13b. In the other internal electrodes 12a and 12b, the section within the end margin section 64 is the second portion 13b, the section within an end portion 63 on the end margin section 64 side within the capacity section 60 is the second portion 13b, and the section within a central portion 61x sandwiched between the two end portions 63 in the X direction is the first portion 13a.

As illustrated in FIG. 3, side margin sections 66 are ends of the element body 10 in the Y direction, where the internal electrodes 12a and 12b are not provided. The side margin section 66 is formed by the side dielectric layers 18a and 18b. In each of the internal electrodes 12a and 12b other than the uppermost internal electrode 12a and the lowermost internal electrode 12b in the Z direction, the section within an end portion 65 on the side margin section 66 side of the capacity section 60 in the Y direction is the second portion 13b, and the section within a central portion 61y sandwiched between the end portions 65 in the Y direction is the first portion 13a.

As illustrated in FIG. 2, FIG. 4, and FIG. 5, the portions of the internal electrodes 12a and 12b that exist within the end margin section 64 of the element body 10 are all second portions 13b.

As described above, the capacity section 60 has the second portions 13b of the internal electrodes 12a and 12b at both ends in the X, Y, and Z directions, and the first portions 13a of the internal electrodes 12a and 12b at the center in each of the X, Y, and Z directions. In other words, the second portions 13b of the internal electrodes 12a and 12b are provided on the surface of the capacity section 60, and the first portions 13a of the internal electrodes 12a and 12b are provided inside the capacity section 60.

The external electrode 20a contacts the internal electrode 12a exposed from the element body 10 at the end face 51. The external electrode 20b contacts the internal electrodes 12b exposed from the element body 10 at the end face 52. The external electrode 20a covers the end face 51, as well as the end of the side faces 53, 54, the lower face 55, and the upper face 56 in the −X direction. The external electrode 20b contacts the internal electrodes 12b at the end face 51. The external electrode 20b covers the end faces in the +X direction of the side faces 53 and 54, the lower face 55, and the upper face 56, in addition to the end face 52.

The size of the multilayer ceramic capacitor 100 is, for example, a length (length in the X direction) of 0.25 mm, a width (width in the Y direction) of 0.125 mm, and a height (height in the Z direction) of 0.125 mm, or a length of 0.4 mm, a width of 0.2 mm, and a height of 0.2 mm, or a length of 0.6 mm, a width of 0.3 mm, and a height of 0.3 mm, or a length of 1.0 mm, a width of 0.5 mm, and a height of 0.5 mm, or a length of 3.2 mm, a width of 1.6 mm, and a height of 1.6 mm, or a length of 4.5 mm, a width of 3.2 mm, and a height of 2.5 mm, but is not limited to these sizes.

The thickness of the side dielectric layers 18a and 18b is, for example, 10 μm or more and 30 μm or less. The length of the end margin region 64 in the X direction is, for example, 10 μm or more and 50 μm or less.

The internal electrodes 12a and 12b are mainly composed of nickel (Ni). The thickness of the internal electrodes 12a and 12b is, for example, 0.1 μm or more and 1 μm or less.

The dielectric layer 14 is mainly composed of a ceramic material having a perovskite structure represented by the general formula ABO₃. The perovskite structure may be ABO_{3-α}, which deviates from the stoichiometric composition. For example, the ceramic material may be selected from at least one of barium titanate (BaTiO₃), calcium zirconate (CaZrO₃), calcium titanate (CaTiO₃), strontium titanate (SrTiO₃), magnesium titanate (MgTiO₃), or Ba_{1-x-y}CaₓSr_{y}Ti_{1-z}Zr_{z}O₃ (0≤x≤1, 0≤y≤1, 0≤z=1) that forms a perovskite structure. Ba_{1-x-y}CaₓSr_{y}Ti_{1-z}Zr₂O₃ is such as barium strontium titanate, barium calcium titanate, barium zirconate, barium titanate zirconate, calcium titanate zirconate, and barium calcium titanate zirconate. For example, the dielectric layer 14 contains 90 at % or more of the main component ceramic. The thickness of the dielectric layer 14 is, for example, 0.3 μm or more and 2 μm or less.

The dielectric layer 14 may contain additives. Examples of additives to the dielectric layer 14 is such as oxides of zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)), oxides containing cobalt (Co), nickel (Ni), lithium (Li), boron (B), sodium (Na), potassium (K), or silicon (Si), or glasses containing cobalt, nickel, lithium, boron, sodium, potassium, or silicon.

The composition of the main ceramic component of the cover dielectric layers 16a, 16b and the side dielectric layers 18a and 18b may be the same as or different from the main ceramic component of the dielectric layer 14.

A layer (a base metal layer 22) of the external electrodes 20a and 20b that is in contact with at least the internal electrodes 12a and 12b is mainly composed of copper (Cu) and contains ceramics such as a glass component for densifying the external electrodes 20a and 20b and a co-material for controlling the sintering property of the external electrodes 20a and 20b. The glass component is an oxide of barium (Ba), strontium (Sr), calcium (Ca), zinc, aluminum, silicon, boron, or the like. The co-material is, for example, a ceramic component whose main component is the same material as the main component of the dielectric layer 14. Note that a plated film whose main component is, for example, a base metal such as nickel, copper, or tin may be formed on the surface of the external electrodes 20a and 20b. Furthermore, a film of conductive resin such as epoxy resin and urethane resin may be formed on the surface of the plating film.

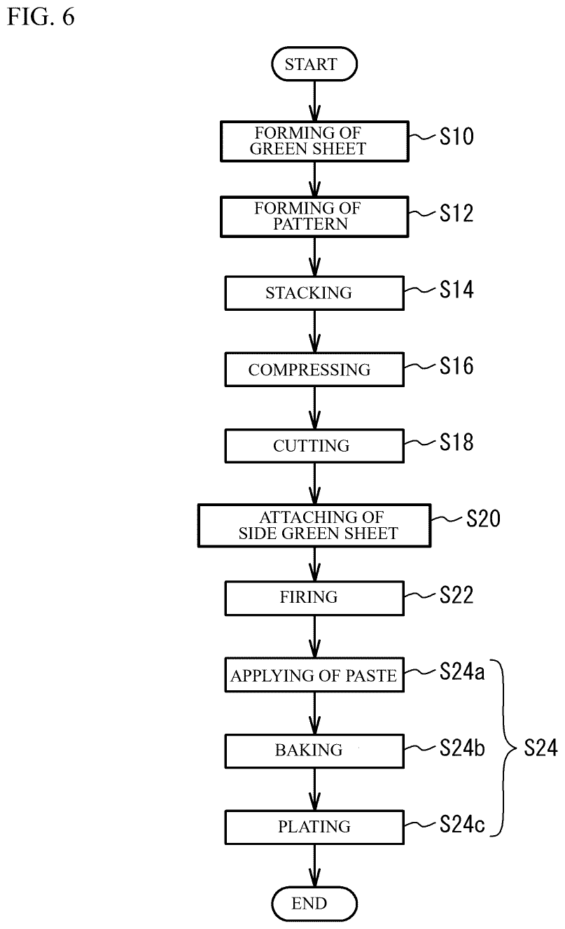

(Method of manufacturing a multilayer ceramic capacitor) A method of manufacturing the multilayer ceramic capacitor 100 will be described. FIG. 6 is a flowchart of a method of manufacturing a multilayer ceramic capacitor according to an embodiment.

(Forming Process of Green Sheet) First, a green sheet 30 is formed (Process S10). In Process S10, a dielectric material is prepared by adding various additive compounds (such as sintering aids) to ceramic powder, for example. A binder such as polyvinyl butyral (PVB) resin, an organic solvent such as ethanol or toluene, and a plasticizer are added to the prepared dielectric material and wet mixed to generate a slurry. The generated slurry is used to coat the green sheet 30 on a substrate, for example, by a die coater method or a doctor blade method. The substrate is, for example, a PET (polyethylene terephthalate) film. The green sheet 30 is then dried.

Similarly, green sheets 31 for the cover dielectric layers 16a, 16b and the side dielectric layers 18a and 18b are formed. Copper or a copper compound is added to the dielectric material for the green sheet 31. The copper compound is, for example, copper oxide (CuO or CuO₂). As a result, the copper concentration in the green sheet 31 becomes higher than that in the green sheet 30.

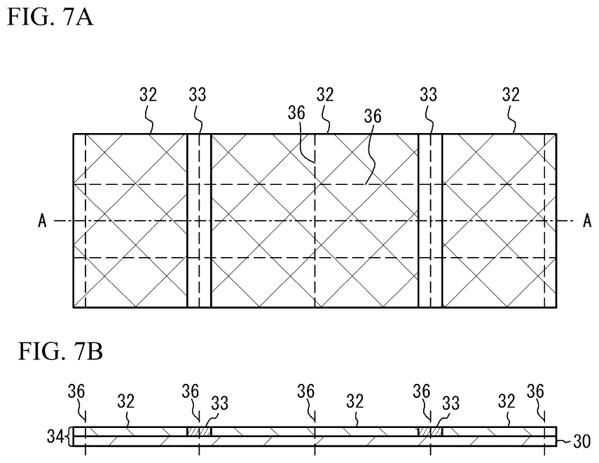

(Forming Process of Pattern) Subsequently, a metal pattern 32 and a dielectric pattern 33 are formed on the green sheet 30 or 31 (step S12). FIG. 7A is a plan view of a method for manufacturing the multilayer ceramic capacitor according to the embodiment, and FIG. 7B is a cross-sectional view taken along a line A-A in FIG. 7A. A cutting line 36 in FIG. 7A and FIG. 7B is the cutting line along which a stack sheet 35 is cut in step S18.

In step S12, first, a metal paste containing nickel powder, an organic binder, and an organic solvent is prepared. The metal paste may contain ceramic particles as a co-material without adding copper. As illustrated in FIG. 7A and FIG. 7B, the metal paste is printed on the green sheet 30 using, for example, a gravure printing method to form the metal pattern 32.

Next, a dielectric paste containing ceramic powder, copper powder or copper compound powder, an organic binder, an organic solvent, and a plasticizer is prepared. The copper compound is, for example, copper oxide (CuO or CuO₂). The dielectric paste is printed on the green sheet 30 using, for example, a gravure printing method to form the dielectric pattern 33. The dielectric pattern 33 is a reverse pattern of the metal pattern 32, and it is preferable that there is almost no gap between the dielectric pattern 33 and the metal pattern 32.

As a result of the above, a stack sheet 34 is formed in which the metal pattern 32 and the dielectric pattern 33 are formed on the green sheet 30. Similarly to the green sheet 31, the metal pattern 32 and the dielectric pattern 33 are formed on the green sheet 31 for the cover dielectric layer 16a to form a stack sheet 34a.

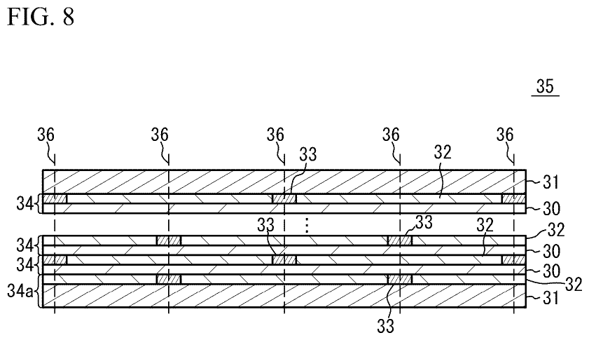

(Stacking Process) Then, the green sheets 31 and the stack sheets 34a are stacked (step S14). FIG. 8 is a cross-sectional view of the method for manufacturing the multilayer ceramic capacitor according to the embodiment, and corresponds to the A-A cross section of FIG. 7A. In step S14, the plurality of stack sheets 34 are stacked on the stack sheet 34a, and finally, the green sheet 31 for the cover dielectric layer 16b is stacked. This forms the stack sheet 35 in which the stack sheet 34a and the plurality of stack sheets 34 are stacked. At this time, the metal patterns 32 are provided alternately so that the position in the X direction is shifted for each layer.

(Compressing Process) Then, the stack sheet 35 is compressed (step S16). In step S16, the stack sheet 35 formed in step S14 is pressed to bond the plurality of stack sheets 34a and 34 together. As the compression means, for example, a hydrostatic press is used.

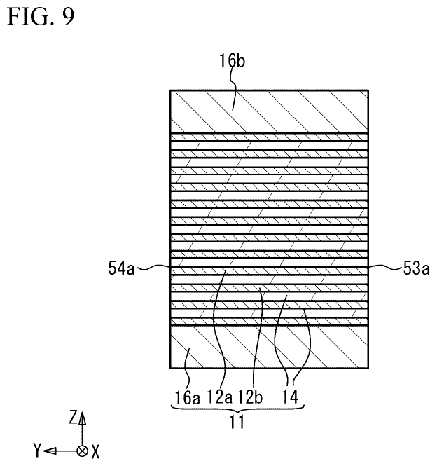

(Cutting Process) Then, the stack sheet 35 is cut (step S18). In step S18, a cutting blade is used to cut the stack sheet 35 in the stacking direction along the predetermined cutting line 36, thereby preparing a plurality of multilayer bodies 11. FIG. 9 is a cross-sectional view of a method for manufacturing the multilayer ceramic capacitor according to the embodiment, and corresponds to the cross section of line B-B in FIG. 1 to FIG. 5. As illustrated in FIG. 9, in the multilayer body 11, the internal electrodes 12a and 12b are exposed from side faces 53a and 54a.

(Attaching Process of Side Green Sheet) Then, the side green sheet is attached (step S20). In step S20, the side face 53a of the multilayer body 11 is pressed against the green sheet 31 for the side dielectric layer 18a, thereby attaching the green sheet 31 to the side face 53a. Similarly, the green sheet 31 is attached to the side face 54a of the multilayer body 11. After step S22, the element body 10 may be polished by a method such as barrel polishing. This rounds the corners of the element body 10.

(Firing Process) Then, the multilayer body 11 with the green sheet 31 attached to each of the side faces 53a and 54a is fired (step S22). In step S22, the multilayer body 11 with the green sheets 31 attached is subjected to a binder removal process in a nitrogen gas atmosphere at 250° C. to 500° C., and then fired in a reducing atmosphere at 1300° C. to 1400° C. This sinters the particles in the multilayer body 11 and the green sheets 31. During the binder removal process, which is performed at a lower temperature than the firing process, the copper in the green sheet 31 and the dielectric pattern 33 diffuses into the metal pattern 32. If the green sheet 31 and the dielectric pattern 33 contain copper as copper oxide, the copper oxide is reduced and diffuses into the internal electrodes 12a and 12b. Hydrogen gas may be included in the binder removal process atmosphere so that the copper oxide is reduced. This increases the molar ratio of copper in the second portion 13b in FIG. 2 to FIG. 4. On the other hand, copper does not diffuse into the first portion 13a as much as in the second portion 13b, and the molar ratio of copper in the first portion 13a is smaller than that in the second portion 13b. By the binder removal process, most of the copper in the green sheet 31 and the dielectric pattern 33 moves to the second portion 13b.

In the binder removal process, copper mainly diffuses into the second portion 13b, so that the copper in the green sheet 31 and the dielectric pattern 33 reacts with nickel near the surfaces of the internal electrodes 12a and 12b during the firing process, and the expansion of the internal electrodes 12a and 12b can be suppressed.

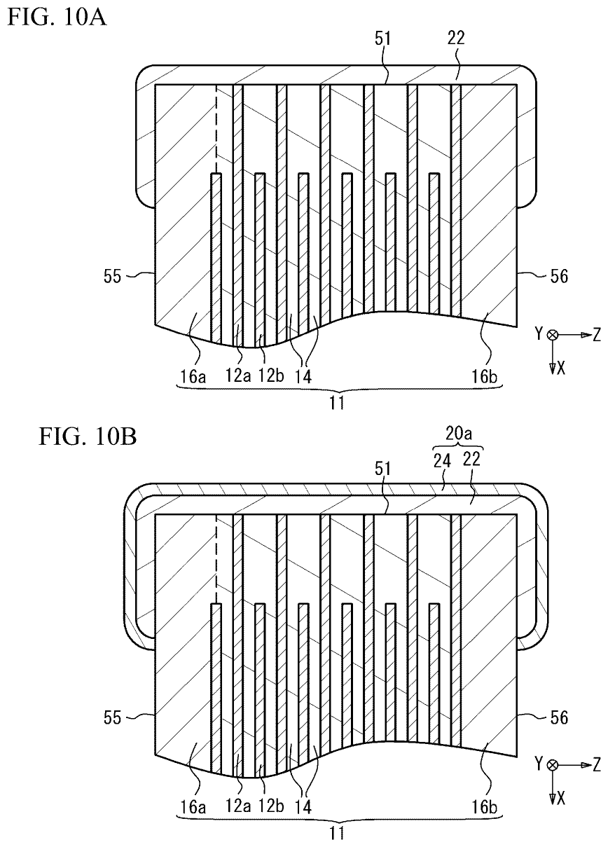

(Forming Process of Eternal Electrode) Next, the external electrodes 20a and 20b are formed (step S24). Step S24 includes steps S24a to S24c. FIG. 10A and FIG. 10B are cross-sectional views of a method for manufacturing the multilayer ceramic capacitor according to the embodiment, and illustrate a cross section similar to that illustrated in FIG. 2. In step S24a, a metal paste containing copper powder, an organic binder, and an organic solvent is prepared. The metal paste may contain ceramic particles as a co-material. As illustrated in FIG. 10A, the metal paste is applied to the entire end face 51 of the element body 10, and to the ends of the side faces 53, 54, the lower face 55, and the upper face 56 on the end face 51 side, for example, by a dipping method.

Next, in step S24b, the metal paste is baked in a nitrogen atmosphere at 750° C. to 850° C., which is lower than the firing temperature in step S22. As a result, the metal paste is baked onto the element body 10, and the base metal layer 22 is formed. At this time, copper diffuses from the base metal layer 22 into the element body 10. However, since copper is already contained in the second portions 13b of the internal electrodes 12a and 12b, the diffusion of copper is suppressed.

In step S24c, as illustrated in FIG. 10B, a plating process is performed to form a plated layer 24 on the base metal layer 22. The plated layer 24 is, for example, a layer mainly composed of copper, a layer mainly composed of nickel, and a layer mainly composed of tin from the base metal layer 22 side. The base metal layer 22 and the plated layer 24 form the external electrodes 20a and 20b.

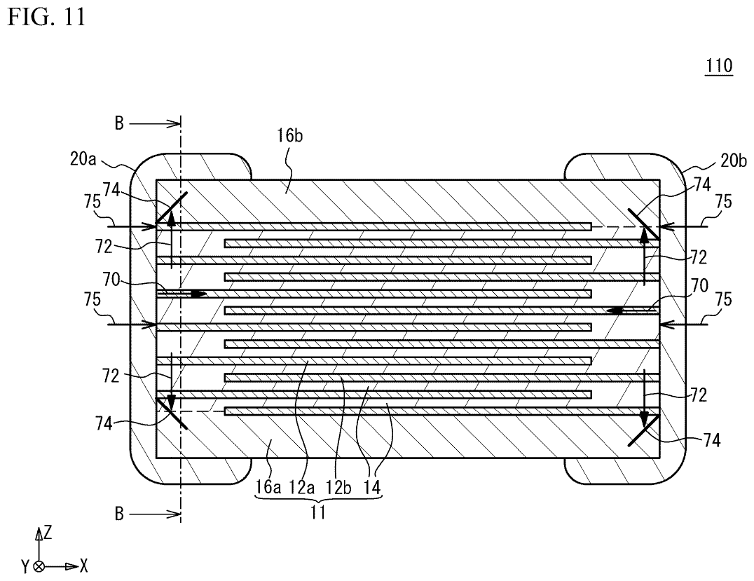

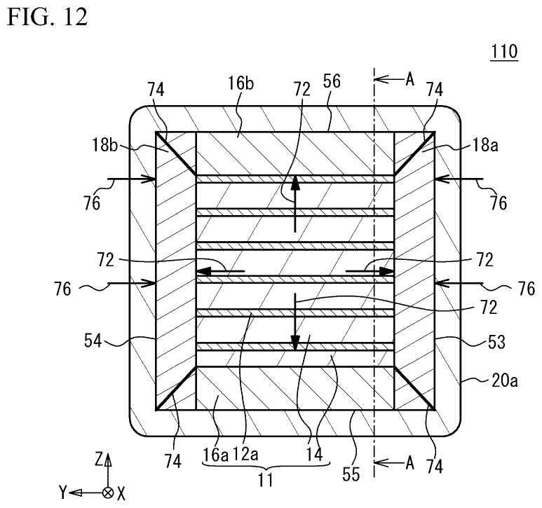

(Comparative Multilayer Ceramic Capacitor) FIG. 11 is a cross-sectional view of a comparative multilayer ceramic capacitor 110, which corresponds to the cross section taken along a line A-A in FIG. 12. FIG. 12 is a cross-sectional view of the comparative multilayer ceramic capacitor 110, which corresponds to the cross section taken along a line B-B in FIG. 11. The comparative multilayer ceramic capacitor 110 is manufactured in a different manner from the multilayer ceramic capacitor 100 of the embodiment in that copper is not added to the green sheet 31 and the dielectric pattern 33 in steps S10 and S12 in FIG. 6.

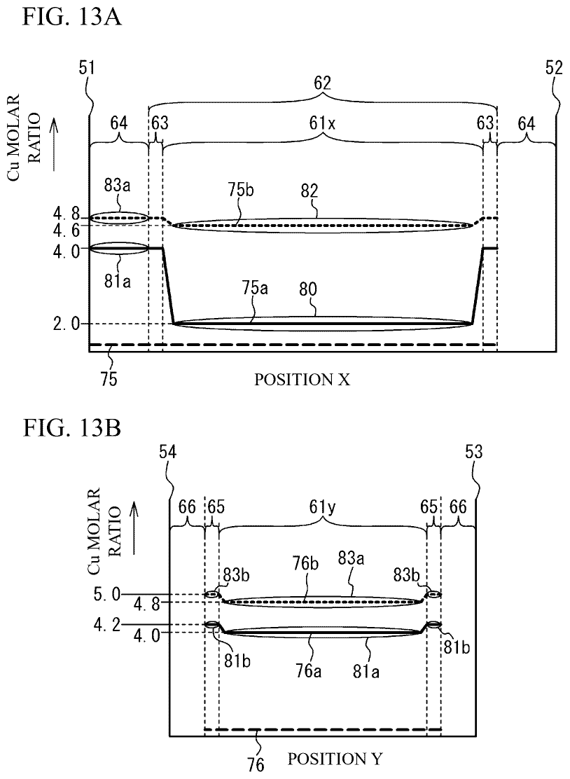

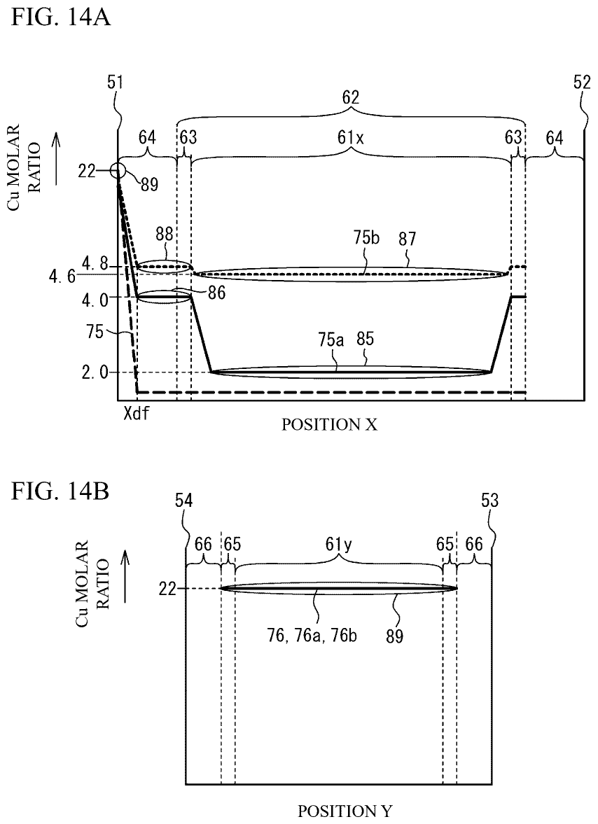

FIG. 13A to FIG. 14B are schematic diagrams of the molar ratio of copper in the internal electrodes. FIG. 13A and FIG. 13B are diagrams of the molar ratio of copper in the internal electrode 12a in the element body 10 after step S22 and before step S24 in FIG. 6. FIG. 14A and FIG. 14B are diagrams of the molar ratio of copper in the internal electrode 12a in the element body 10 after step S24. FIG. 13A and FIG. 14A illustrate the molar ratio of copper with respect to the position in the X direction in the internal electrode 12a. A line 75 indicates the molar ratio of copper in the internal electrode 12a between the arrows indicated by “75” in FIG. 11 for comparison. Lines 75a and 75b indicate the molar ratio of copper in the internal electrode 12a between the arrows indicated by “75a” and “75b” in FIG. 2 for the embodiment.

FIG. 13B and FIG. 14B indicate the molar ratio of copper with respect to the position in the Y direction in the internal electrode 12a. A line 76 indicates the molar ratio of copper in the internal electrode 12a between the arrows indicated by “76” in FIG. 12 for comparison. Lines 76a and 76b indicate the molar ratio of copper in the internal electrode 12a between the arrows indicated by “76a” and “76b” in FIG. 5 for the embodiment, respectively.

In the comparative multilayer ceramic capacitor 110, copper is not added to the green sheet 31 and the dielectric pattern 33. Therefore, as indicated by the lines 75 and 76 in FIG. 13A and FIG. 13B, the internal electrode 12a does not substantially contain copper after the firing process in step S22.

Furthermore, in step S24, in which the base metal layer 22 is baked, as indicated by the lines 75 and 76 in FIG. 14A and FIG. 14B, the copper in the metal paste that will become the base metal layer 22 diffuses into the internal electrode 12a and reacts with nickel (see an arrow 70 in FIG. 11). This increases the molar ratio of copper in the end margin section 64. At this time, the molar ratio of copper is the largest at the end face 51 of the end margin section 64, and the molar ratio of copper decreases as the position approaches the center portion 62 from the end face 51 in the X direction.

When the diffused copper reacts with the nickel of the internal electrode 12a in the end margin section 64, the internal electrode 12a expands, and stress is applied in the direction of the expansion of the end margin section 64 as indicated by an arrow 72 in FIG. 11 and FIG. 12. This causes a crack 74 to form at the corners of the element body 10 as illustrated in FIG. 11 and FIG. 12.

On the other hand, in the embodiment, the green sheet 31 and the dielectric pattern 33 contain copper in steps S10 and S12 in FIG. 6. Therefore, in the binder removal process in step S22, the copper of the green sheet 31 and the dielectric pattern 33 mainly diffuses into the second portion 13b in the internal electrodes 12a and 12b. This is the knowledge of the present inventors. For example, when copper oxide such as CuO₂ and CuO is added to the green sheet 30 mainly composed of barium titanate and the binder removal process is performed, copper diffuses into the internal electrodes 12a and 12b.

In one example, when the molar ratio of CuO₂ to BaTiO₃ in the green sheet 31 is 2 mol %, the molar ratio of copper to nickel in the internal electrodes 12a and 12b in contact with the green sheet 31 is 4 mol %, and the molar ratio of copper to nickel in the internal electrodes 12a and 12b not in contact with the green sheet 31 is 2 mol %. Also, when the molar ratio of CuO₂ to BaTiO₃ in the green sheet 31 is 5 mol %, the molar ratio of copper to nickel in the internal electrodes 12a and 12b in contact with the green sheet 31 is 9.1 mol %, and the molar ratio of copper to nickel in the internal electrodes 12a and 12b not in contact with the green sheet 31 is 4.7 mol %.

In the element body 10 before the firing step (step S22), the green sheet 31 in the capacity section 60 contains almost no copper. Therefore, when the firing step is performed, almost no copper is diffused into the section in the central portion 61x of the capacity section 60 in the X direction in the internal electrode 12a near the center in the Z direction.

Therefore, as indicated by the line 75a in FIG. 13A, the internal electrode 12a in the central portion 61x contains almost no copper. On the other hand, since the dielectric pattern 33 contains copper before the firing step, copper diffuses from the dielectric pattern 33 to the internal electrode 12a in the end margin section 64 during the firing step.

Therefore, as indicated by the line 75a in FIG. 13A, the molar ratio of copper in the internal electrode 12a in the end margin section 64 is greater than the molar ratio of copper in the internal electrode 12a in the central portion 61x. Furthermore, in the firing process, copper diffuses from the dielectric pattern 33 to the internal electrodes 12a in the end portions 63 of the central portion 62 where the capacity section 60 exists. Therefore, as indicated by the line 75a in FIG. 13A, the copper molar ratio of the internal electrodes 12a in the end portions 63 is greater than the copper molar ratio of the internal electrodes 12a in the central portion 61x, and is substantially the same as the copper molar ratio of the internal electrodes 12a in the end margin section 64.

Before the firing process, the green sheets 31 that will become the cover dielectric layers 16a and 16b contain copper. Therefore, in the firing process, copper diffuses from the green sheets 31 that will become the cover dielectric layers 16a and 16b to the top (or bottom) internal electrodes 12a (12b) in the Z direction. For this reason, as illustrated in FIG. 13A, in the central portion 61x in the X direction of the multilayer body 11, the copper molar ratio (the line 75b) of the uppermost internal electrode 12a is greater than the copper molar ratio (the line 75a) of the internal electrode 12a near the center.

Furthermore, in the firing process, in the end margin section 64, copper diffuses from the green sheet 31 and the dielectric pattern 33 to the uppermost internal electrode 12a in the Z direction. For this reason, as illustrated in FIG. 13A, in the end margin section 64 and the end portion 63, the copper molar ratio (line 75b) of the uppermost internal electrode 12a is greater than the copper molar ratio (line 75a) of the internal electrode 12a near the center.

Before the firing process, the green sheet 31 that will become the side dielectric layers 18a and 18b contains copper. Therefore, during the firing process, copper diffuses from the green sheet 31 that will become the side dielectric layers 18a and 18b to the internal electrodes 12a and 12b in the end portion 65 in the Y-direction end of the capacity section 60.

As illustrated in FIG. 13B, for the internal electrode 12a near the center in the Z direction, the copper molar ratio of the internal electrode 12a in the end portion 65 in the Y-direction end is greater than the copper molar ratio of the internal electrode 12a in the center portion 61y in the Y-direction center (the line 76a). Also, as illustrated in FIG. 13B, in the center portion 61y in the Y direction center, the copper molar ratio of the uppermost internal electrode 12a in the Z direction (the line 76b) is greater than the copper molar ratio of the internal electrode 12a near the center in the Z direction (the line 76a). Even at the end portion 65 in the Y-direction, the copper molar ratio of the uppermost internal electrode 12a (the line 76b) is greater than the copper molar ratio of the internal electrode 12a near the center in the Z direction (the line 76a).

In summary, the copper molar ratio after the sintering process increases in the following order from a range 80 to a range 83b.
The range 80 (copper molar ratio: 2.0): The first portion 13a of the internal electrodes 12a and 12b near the center in the Z direction, which is present in the central portion 61x in the X-direction.
The range 81a (copper molar ratio: 4.0): The second portion 13b of the internal electrodes 12a and 12b near the center in the Z-direction, which is present in the end margin section 64 and in the central portion 61y in the Y-direction.
The range 81b (copper molar ratio: 4.2): The second portion 13b of the internal electrodes 12a and 12b near the center in the Z direction, which is present in the end margin section 64 and in the end portion 65 in the Y direction.
The range 82 (copper molar ratio: 4.6): The second portion 13b of the internal electrodes 12a and 12b at the top or bottom in the Z direction, which is present in the central portion 61x in the X direction.
The range 83 a (copper molar ratio: 4.8): The second portion 13b that exists in the end margin section 64 and in the center portion 61y in the Y direction of the uppermost or lowermost internal electrodes 12a and 12b in the Z direction.
The range 83b (copper molar ratio: 5.0): The second portion 13b that exists in the end margin section 64 and in the end portion 65 in the X direction of the uppermost or lowermost internal electrodes 12a and 12b in the Z direction.

In step S24, when the base metal layer 22 is formed, the internal electrodes 12a and 12b in the end margin section 64 contain copper, so that in the multilayer ceramic capacitor 100 of the embodiment, the copper molar ratio between the base metal layer 22 and the internal electrodes 12a and 12b is higher than that of the comparative multilayer ceramic capacitor 110. Therefore, during the baking step S24b of the base metal layer 22, the diffusion of copper from the base metal layer 22 to the internal electrodes 12a and 12b is suppressed, and the reaction between copper and nickel is suppressed.

As can be understood by comparing the lines 75, 75a, and 75b in FIG. 14A with the lines 75, 75a, and 75b in FIG. 13A, respectively, in the multilayer ceramic capacitors 100 and 110, the copper in the base metal layer 22 diffuses into the section extending from the end face 51 to the position Xdf in the X direction of the end margin section 64. Here, the increase in copper in the end margin section 64 in the multilayer ceramic capacitor 100 of the embodiment is less than that of the comparative multilayer ceramic capacitor 110. Therefore, in the embodiment, the reaction between copper and nickel is suppressed, the stress as indicated by the arrow 72 in FIG. 11 and FIG. 12 is suppressed, and the occurrence of cracks 74 is suppressed.

As indicated by the lines 75a and 75b in FIG. 13A, before step S24, in the end margin section 64, the copper molar ratio of the uppermost internal electrode 12a in the Z direction is greater than that of the internal electrode 12a near the center in the Z direction. Therefore, in the uppermost internal electrode 12a, the diffusion of copper from the base metal layer 22 is more suppressed than in the internal electrode 12a near the center, and the reaction between copper and nickel is more suppressed.

As can be seen by comparing the lines 75a and 75b in FIG. 14A with the lines 75a and 75b in FIG. 13A, respectively, in the end margin section 64, the increase in the molar ratio due to the diffusion of copper to the uppermost internal electrode 12a is less than the increase in the molar ratio due to the diffusion of copper to the internal electrode 12a near the center. Moreover, the diffusion of copper remains within the end margin section 64, and copper does not substantially diffuse into the center portion 62 where the capacity section 60 exists. Furthermore, as indicated by the lines 76, 76a, and 76b in FIG. 14B, near the end face 51, the copper molar ratios of the uppermost internal electrode 12a, the internal electrode 12a near the center, and the internal electrode 12a of the comparative multilayer ceramic capacitor are substantially equal. This is because the base metal layer 22 contains more copper, its main component, than the amount that diffuses into the internal electrodes 12a and 12b.

To summarize the above, the copper molar ratio after the formation of the external electrodes in step S24 increases in the following ranges 85 to 89, in that order.
The range 85 (copper molar ratio: 2.0): The first portion 13a existing in the central portion 61x in the X direction of the internal electrodes 12a and 12b near the center in the Z direction.
The range 86 (copper molar ratio: 4.0): The second portion 13b existing in the end portion 63 and the end margin section 64 on the end portion 63 side in the X direction of the internal electrodes 12a and 12b near the center in the Z direction.
The range 87 (copper molar ratio: 4.6): The second portion 13b existing in the central portion 61x in the X direction of the uppermost or lowermost internal electrodes 12a and 12b in the Z direction.
The range 88 (copper molar ratio: 4.8): The second portion 13b present in the end portion 63 and the end margin section 64 on the end portion 63 side in the X direction, in the uppermost or lowermost internal electrodes 12a and 12b in the Z direction.
The range 89 (copper molar ratio: 22): The second portion 13b existing in the end margin section 64 near the end face 51 in the internal electrodes 12a and 12b.

As described above, in the multilayer ceramic capacitor 100 of the embodiment, compared with the comparative multilayer ceramic capacitor 110, copper is less likely to diffuse from the base metal layer 22 (metal paste) to Ranges 86 and 88 of the internal electrode 12a in the end margin section 64, so that the reaction between copper and nickel is suppressed and the expansion of the internal electrodes 12a and 12b is suppressed. Therefore, the occurrence of cracks 74 as illustrated in FIG. 11 and FIG. 12 can be further suppressed.

According to the embodiment, before step S24, as illustrated in FIG. 13A, the copper molar ratio in the range 81a is greater than the copper molar ratio in the range 80. As a result, after step S24b in which the metal paste is baked, as illustrated in FIG. 14A, the increase in the molar ratio of copper in the end margin section 64 due to copper diffused from the metal paste (the lines 75a and 75b) can be reduced compared to the increase in the molar ratio of copper in the comparative multilayer ceramic capacitor 110 (the line 75). That is, according to the multilayer ceramic capacitor 100 of the embodiment, the amount of copper diffused from the base metal layer 22 to the internal electrodes 12a, 12b after firing can be reduced compared to the comparative multilayer ceramic capacitor 110. Therefore, the reaction between copper and nickel can be suppressed, and the generation of cracks and the like can be suppressed. Furthermore, if copper oxide remains in the cover dielectric layers 16a, 16b, the side dielectric layers 18a, 18b, and the end margin section 64, the density of each is improved, and the strength and moisture resistance of the element body 10 are improved.

The molar ratio of copper in the green sheets 30, 31 and the dielectric pattern 33 is, for example, the molar ratio of copper to the main component metal element of the ceramic. When the main component of the ceramic is barium titanate, the main component metal element is titanium or barium. When there are multiple main component elements, the metal element that is easier to detect can be used as the standard.

In steps S10 and S12, the molar ratio of copper to the main component metal element of the ceramic in the green sheet 31 and the dielectric pattern 33 is preferably 0.1 mol % to 10 mol %. As a result, before the external electrode formation step S24, the molar ratio of copper to nickel in the range 81 is, for example, 0.1 mol % to 20 mol %, and the molar ratio of copper to nickel in the range 80 is, for example, 0 mol % to 10 mol %. For example, when the main component of the ceramic of the green sheet 31 and the dielectric pattern 33 is barium titanate and CuO2 is added as a copper compound, the molar ratio of copper to titanium in the green sheet 31 and the dielectric pattern 33 is 1 mol % to 10 mol %. In this case, the molar ratio of copper to nickel in the range 81 is, for example, 1 mol % to 10 mol %, and the molar ratio of copper to nickel in the range 80 is 0 mol % to 5 mol %.

After step S24, the molar ratio of copper to nickel in the range 86 is greater than the molar ratio of copper to nickel in the range 85. The molar ratio of copper to nickel in the range 85 is set to the molar ratio of copper to nickel in the central portion 61x of the capacity section 60. The molar ratio of copper to nickel in the range 86 is, for example, 1 to 7, and the molar ratio of copper to nickel in the range 85 is, for example, 0.5 to 4.0. The molar ratio of copper to nickel in the range 86 is preferably 1.2 times or more, more preferably 1.5 times or more, and even more preferably 2 times or more, of the molar ratio of copper to nickel in the range 85. When nickel contains copper, the resistance increases. Since the molar ratio of copper in the range 85 in the internal electrodes 12a and 12b in the capacity section 60 is small, the resistance of the internal electrodes 12a and 12b can be reduced, and the characteristics of the capacitor can be improved.

As a method for making the molar ratio of copper in the range 81a in FIG. 13A greater than the molar ratio of copper in the range 80, in FIG. 7A and FIG. 7B, the molar ratio of copper in the ranges 80 and 81 in the metal pattern 32 may be set to a desired value when forming the stack sheet 34. However, it is difficult to change the molar ratio of copper within the same metal pattern 32.

As explained in FIG. 7A to FIG. 8, in the prepared stack sheet 35, the molar ratio of copper to the main component metal elements of the ceramic of the dielectric pattern 33 provided in the end margin section 64 so as to contact the internal electrodes 12a and 12b in the X direction is greater than the molar ratio of copper to the main component metal elements of the ceramic of the green sheet 30 overlaid on the internal electrodes 12a and 12b in the Z direction. In step S22, the stack sheet 35 is fired. This makes it possible to more easily increase the molar ratio of copper in the range 81a in FIG. 13A than the molar ratio of copper in the range 80.

Before step S24, as illustrated in FIG. 13B, the molar ratio of copper to nickel in the range 83a is higher than the molar ratio of copper to nickel in the range 81a. The molar ratio of copper to nickel in the range 83a is, for example, 1.5 to 7.5. As a result, in the end margin section 64, the reaction between copper and nickel is suppressed in the second portions 13b of the uppermost or lowermost internal electrodes 12a and 12b compared to the second portions 13b of the internal electrodes 12a and 12b around the center, and the expansion of the internal electrodes 12a and 12b is suppressed. Therefore, the occurrence of the cracks 74 can be further suppressed. The molar ratio of copper in the range 88 is preferably, for example, 1.2 times or more, more preferably 1.5 times or more, of the molar ratio of copper in the range 86.

As a method for making the copper molar ratio in the range 82 greater than that in the range 80, copper may be added to the green sheet 31 that will become the cover dielectric layers 16a and 16b in FIG. 7A and FIG. 7B. When manufactured in this manner, as illustrated in FIG. 14A, the copper to nickel molar ratio in the range 87 of the outermost internal electrodes 12a and 12b in the Z direction is greater than the copper to nickel molar ratio in the range 85 of the internal electrodes 12a and 12b around the center. The copper molar ratio in the range 87 is, for example, 1.5 to 7.5. The copper molar ratio in the range 89 is preferably twice or more, more preferably three times or more, and even more preferably four times or more of the copper molar ratio in the range 85.

Furthermore, before step S24, as illustrated in FIG. 13B, the copper to nickel molar ratio in the range 81b is higher than the copper to nickel molar ratio in the range 81a. A method for making the copper molar ratio in the range 81b larger than that in the range 81a is to add copper to the green sheet 31 that will become the side dielectric layers 18a and 18b in step S10 of forming the green sheet 30. When manufactured in this manner, the molar ratio of copper to nickel in the second portion 13b that is the end portion of the internal electrodes 12a and 12b in the Y direction in the capacity section 60 is larger than the molar ratio of copper to nickel in the first portion 13a that is the center portion of the internal electrodes 12a and 12b in the Y direction. Therefore, by increasing the molar ratio of copper in the internal electrodes 12a and 12b near the side margin section 66, the diffusion of copper itself is reduced, and the occurrence of cracks due to the above-mentioned volume expansion can be suppressed. In particular, since the corners of the element body 10 are the starting points of cracks, the occurrence of cracks can be more effectively suppressed by suppressing the diffusion of copper to the corners.

In the embodiment, as illustrated in FIG. 13A, the molar ratio of copper to nickel of the top or bottom internal electrodes 12a and 12b in the Z direction is made larger than the molar ratio of copper to nickel of the central internal electrodes 12a and 12b in the Z direction, however the molar ratio of copper to nickel may be the same between the top or bottom and central internal electrodes 12a and 12b. As illustrated in FIG. 13B, the molar ratio of copper to nickel of the internal electrodes 12a and 12b in the end portion 65 is made larger than the molar ratio of copper to nickel of the internal electrodes 12a and 12b in the central portion 61y. However, the molar ratio of copper to nickel may be substantially the same between the end portion 65 and the central portion 61y.

When the molar ratio of copper to nickel is the same between the end portion 65 and the central portion 61y, the side margin section 66 may be formed from the stack sheet 35 without performing step S20 in FIG. 6.

In step S12, the metal paste does not contain copper, but it may contain copper.

In this embodiment, the molar ratio is measured using, for example, EDS (Energy Dispersive X-ray Spectroscopy) or WDS (Wavelength Dispersive Spectroscopy). The molar ratio of copper to nickel in the internal electrodes 12a and 12b in the end margin section 64 is the molar ratio of copper to nickel around the center in the X direction of the end margin section 64. The molar ratio of copper to nickel in the internal electrodes 12a and 12b in the capacity section 60 is the molar ratio of copper to nickel around the center in the X direction of the capacity section 60. When comparing the molar ratios of copper to nickel of the internal electrodes 12a and 12b in the portion of the end margin section 64 on the side of the end faces 51 and 52, the molar ratios are compared at locations in the end margin section that are 5 μm or less in the X direction from the end faces 51 and 52, and the distances from the end faces 51 and 52 are the same. When comparing the molar ratios of copper to nickel of the end portions 65 of the internal electrodes 12a and 12b in the Y direction, the molar ratios are compared at locations that are 5 μm or less in the Y direction from the ends of the internal electrodes 12a and 12b, and the distances from the end faces 51 and 52 are the same.

When a certain member is composed mainly of a certain element, it is sufficient that the certain element is contained in the certain member to the extent that the effect of the embodiment is achieved, and the concentration of the certain element in the certain member is, for example, 50 mol % or more, 80 mol % or more, or 90 mol % or more.

Although the embodiments of the present invention have been described in detail, it is to be understood that the various change, substitutions, and alterations could be made hereto without departing from the spirit and scope of the invention.

What is claimed is:

1. A multilayer ceramic electronic device comprising:
an element body in which each of a plurality of internal electrodes of which a main component is nickel and each of a plurality of dielectric layers of which a main component is ceramic are alternately stacked in a first direction, each of the plurality of internal electrodes being alternately exposed to each of a pair of end faces of the element body, the pair of end faces facing each other in a second direction; and
a pair of external electrodes each contacting each of the plurality of internal electrodes exposed from each of the pair of end faces and having a layer in contact with each of the plurality of internal electrodes, and of which a main component is copper,
wherein an end margin section is an end portion in the second direction of the element body as viewed from the first direction, the end margin section including, among the plurality of internal electrodes, a first internal electrode exposed to one of the pair of end faces and not including a second internal electrode exposed to other of the pair of end faces,
wherein a molar ratio of copper to nickel in the first internal electrode in the end margin section is greater than a molar ratio of copper to nickel in the first internal electrode in a capacity section, and
wherein the capacity section is a section in which the first internal electrode and the second internal electrode overlap each other, which is a central portion in the second direction of the element body as viewed from the first direction.

2. The multilayer ceramic electronic device as claimed in claim 1,
wherein, in the capacity section, among the plurality of internal electrodes, a molar ratio of copper to nickel of an internal electrode located on an outermost side in the first direction is greater than a molar ratio of copper to nickel of an internal electrode located in a center portion in the first direction.

3. The multilayer ceramic electronic device as claimed in claim 1,
wherein, in the capacity section, a molar ratio of copper to nickel at an end portion of at least one of the plurality of internal electrodes in a third direction substantially orthogonal to the first direction and the second direction is greater than a molar ratio of copper to nickel at a center portion of the at least one of the plurality of internal electrodes in the third direction.

4. A manufacturing method of a multilayer ceramic electronic device, the method comprising:
preparing an element body in which each of a plurality of internal electrodes of which a main component is nickel and each of a plurality of dielectric layers of which a main component is ceramic are alternately stacked in a first direction, each of the plurality of internal electrodes being alternately exposed to each of a pair of end faces of the element body, the pair of end faces facing each other in a second direction, wherein an end margin section is an end portion in the second direction of the element body as viewed from the first direction, the end margin section including, among the plurality of internal electrodes, a first internal electrode exposed to one of the pair of end faces and not including a second internal electrode exposed to other of the pair of end faces, wherein a molar ratio of copper to nickel in the first internal electrode in the end margin section is greater than a molar ratio of copper to nickel in the first internal electrode in a capacity section, and wherein the capacity section is a section in which the first internal electrode and the second internal electrode overlap each other, which is a central portion in the second direction of the element body as viewed from the first direction; and
forming a pair of external electrodes each contacting each of the plurality of internal electrodes exposed from each of the pair of end faces and having a layer in contact with each of the plurality of internal electrodes, and of which a main component is copper.

5. The method as claimed in claim 4,
wherein the forming of the pair of external electrodes comprises:
applying a metal paste so as to contact each of the plurality of internal electrodes exposed from each of the pair of end faces; and
baking the metal paste.

6. The method as claimed in claim 4,
wherein the preparing of the element body comprises:
preparing a stack sheet in which a molar ratio of copper to a main metal element of a ceramic of a dielectric pattern provided in the end margin section so as to contact the second internal electrode in the second direction is greater than a molar ratio of copper to a main metal element of a ceramic of a green sheet overlying the first internal electrode and the second internal electrode in the first direction; and
firing the stack sheet.

7. The method as claimed in claim 4,
wherein, before the forming of the pair of external electrode, in the capacity section, a molar ratio of copper to nickel of an internal electrode located outermost in the first direction among the plurality of internal electrodes is greater than a molar ratio of copper to nickel of an internal electrode located at a center portion in the first direction.

8. The method as claimed in claim 4,
wherein, before the forming of the external electrode, in the capacity section, a molar ratio of copper to nickel at an end of at least one of the plurality of internal electrodes in a third direction substantially orthogonal to the first direction and the second direction is greater than a molar ratio of copper to nickel at a center portion of the at least one of the plurality of internal electrodes in the third direction.
